(19) United States
(12) Patent Application Publication
(10) Pub. No.: US 2022/0098691 A1
(43) Pub. Date: Mar. 31, 2022

(54) METHOD FOR MANUFACTURING GRAIN-ORIENTED ELECTRICAL STEEL SHEET

(71) Applicant: NIPPON STEEL CORPORATION, Tokyo (JP)

(72) Inventors: Masato YASUDA, Tokyo (JP); Masaru TAKAHASHI, Tokyo (JP); Yoshiyuki USHIGAMI, Tokyo (JP); Shohji NAGANO, Tokyo (JP); Yoichi ZAIZEN, Tokyo (JP)

(73) Assignee: NIPPON STEEL CORPORATION, Tokyo (JP)

(21) Appl. No.: 17/421,824

(22) PCT Filed: Jan. 16, 2020
(86) PCT No.: PCT/JP2020/001167

§ 371 Date: Jul. 9, 2021

(30) Foreign Application Priority Data
Jan. 16, 2019 (JP) 2019-005202

(51) Int. Cl. C21D 9/46; C21D 8/12; C21D 6/00; C21D 3/04; C22C 38/34; C22C 38/16; C22C 38/60; C22C 38/08; C22C 38/06; C22C 38/04; C22C 38/02; C22C 38/00; H01F 1/147

(52) U.S. Cl. CPC C21D 9/46; C22C 2202/02; C21D 8/1233; C21D 8/1255; C21D 8/1272; C21D 6/008; C21D 3/04; C21D 6/005; C21D 6/002; C22C 38/34; C22C 38/16; C22C 38/60; C22C 38/08; C22C 38/06; C22C 38/04; C22C 38/02; C22C 38/008; C22C 38/002; C22C 38/001; H01F 1/147; C21D 2201/05; C21D 8/1222

(57) ABSTRACT

A method for manufacturing a grain-oriented electrical steel sheet includes: heating a steel slab having a prescribed chemical composition to lower than 1250° C. and subjecting the steel slab to hot rolling to obtain a hot-rolled steel sheet; performing hot-band annealing on the hot-rolled steel sheet; pickling the hot-rolled steel sheet which has been subjected to the hot-band annealing; subjecting the hot-rolled steel sheet which has been subjected to the pickling to cold rolling to obtain a cold-rolled steel sheet having a final sheet thickness d of 0.15 to 0.23 mm; performing a decarburization nitriding treatment including decarburization annealing and nitriding on the cold-rolled steel sheet; performing final annealing on the cold-rolled steel sheet which has been subjected to the decarburization nitriding treatment; and then applying a coating liquid for insulation coating formation to the cold-rolled steel sheet which has been subjected to the final annealing and baking the cold-rolled steel sheet. Sol. Al/N which is a mass ratio between Sol. Al and N in the steel slab and the final sheet thickness d satisfy a prescribed relational expression, the N content of the cold-rolled steel sheet which has been subjected to the decarburization nitriding treatment is 40 to 1000 ppm, and a decarburization annealing temperature in the decarburization annealing is lower than 1000° C.

### TECHNICAL FIELD

The present invention relates to a method for manufacturing a grain-oriented electrical steel sheet.

Priority is claimed on Japanese Patent Application No. 2019-005202, filed Jan. 16, 2019, the, content of which is incorporated herein by reference.

### BACKGROUND ART

Grain-oriented electrical steel sheets are soft magnetic material and are used for iron cores of transformers and other electric devices. Grain-oriented electrical steel sheets are steel <sheets which contain about 7 mass % or less of Si and include grains highly aligned the {110} <001> orientation in the Miller index.

As the magnetic characteristics of the grain-oriented electrical steel sheets used for the above applications, it is required that magnetic flux density (represented by a magnetic flux density B8 value when a magnetic field of 800 A/m is applied) is high and iron loss (represented by energy loss W_{17/50} when magnetization has been performed at ,a maximum magnetic flux density 1.7 T with an alternating current (AC) at a frequency of 50 Hz) is low. Particularly, in recent years, there is an increasing demand for reducing electric power loss from the viewpoint of energy saving.

The iron loss, of electrical steel sheets is determined using a sum of the eddy current loss which depends on the specific resistance, the sheet thickness, the size of the magnetic domain, and the like and the hysteresis loss which depends on the crystal orientation, the smoothness of the surface, and the like. Therefore, in order to reduce the iron loss, it is necessary to reduce one or both of the eddy current loss and the hysteresis loss.

As a method for reducing eddy current loss, a method for increasing the content of Si having a high electric resistance, a method for reducing a sheet thickness of a steel sheet, a method for subdividing a magnetic domain, and the like are known. Furthermore, as a method for reducing hysteresis loss, a method for increasing a magnetic flux density B8 by increasing a degree of alignment of an easy magnetization orientation of a crystal orientation and a method for removing a glass coating made of, an oxide on the surface of the steel sheet to smooth the surface and eliminating a pinning effect in which the movement of a magnetic domain is hindered are known.

In these method for reducing iron loss, as a method for smoothing a surface of a steel sheet, for example, Patent Documents 1 to 5 describe a method in which decarburization annealing is performed in an atmosphere gas with an oxidation degree in which Fe-based oxides (Fe₂SiO₄, FeO, and the like) are not generated, and a glass coating (a forsterite coating) is not formed using an annealing separator which contains alumina as a main component as an annealing separator arranged, between steel sheets.

Although a method for reducing, a sheet thickness through rolling is known as a method for reducing a sheet thickness of a steel sheet, if a thin sheet thickness is provided, there is a problem in which secondary recrystallization in final annealing is unstable and it is difficult to stably manufacture a product having excellent magnetic characteristics.

In order to solve his problem, for example, Patent Document 6 proposes a method for manufacturing a grain-oriented electrical steel sheet in which a cold-rolled steel sheet having a sheet thickness d mm of 0.10 to 0.25 mm is subjected to decarburization annealing and nitriding and AlN is utilized as an inhibitor and a thin grain-oriented electrical steel sheet is stably manufactured by setting acid-soluble Al to 0.015 to 0.050%, making the nitrogen content [N] of a steel sheet satisfy 13d−25≥[N]≥46d−1030 using nitric acid, and strengthening an inhibitor.

However, the method of Patent Document 6 has a problem in which the coating properties are poor because a large amount of nitrogen is released after a glass coating is formed.

### Prior Art Document

### [Patent Document]

### [Patent Document 1]

Japanese Unexamined Patent Application, First Publication No. H07-118750

### [Patent Document 2]

Japanese Unexamined Patent Application, First Publication No. H07-278668

### [Patent Document 3]

Japanese Unexamined Patent Application, First Publication No. H07-278669

### [Patent Document 4]

Japanese Unexamined Patent Application, First Publication No. 2003-003213

### [Patent Document 5]

Published Japanese Translation No. 2011-518253 of the PCT International Publication

### [Patent Document 6]

Japanese Unexamined Patent Application, First Publication No. F105-302122

### SUMMARY OF THE INVENTION

### Problems to be Solved by the Invention

Although it is assumed that the problems of the method of Patent Document 6 can be solved by incorporating a method for smoothing a surface of a steel sheet without forming a glass coating (a forsterite coating) as shown in Patent Documents 1 to 5, in the method for smoothing, a surface of a steel sheet, it is difficult to secure a good decarburization property and an inferior decarburization property is provided when the Al content increases. Therefore, if the Al content increases to stably obtain a secondary recrystallization structure in a thin electrical steel sheet, it is difficult to achieve both decarburization property and excellent magnetic characteristics.

Thus, in order to stably obtain a good secondary recrystallization structure, in a grain-oriented electrical steel sheet containing a required amount of Al, the problems of the present invention is to reduce iron loss by reducing a sheet thickness, to secure a good decarburization property, to, improve magnetic characteristics (to reduce iron loss and to secure a high magnetic flux density) and an object of the present invention is to provide a method for manufacturing a grain-oriented electrical steel sheet in which the problems are solved.

### Means for Solving the Problem

In order to solve the above problems, the inventors of the present invention have investigated a relationship between the Al content and a sheet thickness to stably obtain secondary recrystallization and secure a good decarburization property in a thin grain-oriented electrical steel sheet manufactured using a method for smoothing a surface of the steel sheet.

As a result, it was found that, if a mass ratio: Sol. Al/N between acid-soluble Al (Sol. Al) and N in a steel slab which is used as a material is controlled within an appropriate range in accordance with a product sheet thickness, that is, a final sheet thickness d after cold rolling, it is possible to secure a good decarburization property in decarburization annealing, and if the N content in the steel sheet which has been subjected to nitriding is controlled within an appropriate range, it is possible to obtain good secondary recrystallization in final annealing. This point will be described later.

The present invention was made on the basis of the above findings, and the gist of the present invention is as follows.

(1)A method for manufacturing a grain-oriented electrical steel sheet according to an aspect of the present invention is a method for manufacturing a grain-oriented electrical steel sheet, including: heating a steel slab which contains, in terms of mass %, C: 0.100% or less; Si: 0.80 to 7.00%; Mn: 0.05 to 1.00%; Sol. Al: 0.0100 to 0.0700%; N: 0.0040 to 0.0120%; Seq=S+0.406×Se: 0.0030 to 0.0150%; Cr: 0 to 0.30%; Cu: 0 to 0.40%; Sn: 0 to 0.30%; Sb: 0 to 0.30%; P: 0 to 0.50%; B: 0 to 0.0080%; Bi: 0 to 0.0100%; Ni: 0 to 1.00%, and the remainder: Fe and impurities to lower than 1250° C. and subjecting the steel slab to hot rolling to obtain a hot-rolled steel sheet; performing hot-band annealing on the hot-rolled steel sheet; pickling the hot-rolled steel sheet which has been, subjected to the hot-band annealing; subjecting the hot-rolled steel sheet which has been subjected to the pickling to cold rolling to obtain a cold-rolled steel sheet having a final sheet thickness, d of 0.15 to 0.23 mm; performing a decarburization nitriding treatment including decarburization annealing and nitriding on the cold-rolled steel sheet; performing final annealing on the cold-rolled steel sheet which has been subjected to the decarburization nitriding treatment; and a coating liquid for insulation coating formation to the cold-rolled steel sheet which has been subjected to the final annealing and baking the coating liquid, wherein Sol. Al/N which is a mass ratio between Sol. Al and N in the steel slab and the final sheet thickness d satisfy the following expression (i), the N content of the cold-rolled steel sheet which has been subjected to the decarburization nitriding treatment is 40 to 1000 ppm, and a decarburization annealing temperature in the decarburization annealing is lower than 1000° C.: −4.17×d+3.63≤Sol. Al/N≤−3.10×d+4.84 (i).

(2) In the method for manufacturing a grain-oriented electrical steel sheet according to (1) above, the steel slab may contain, in terms of mass %, one or more of Cr: 0.02 to 0.30%; Cu: 0.10 to 0.40%; Sn: 0.02 to 0.30%; Sb: 0.02 to 0.30%; P: 0.02 to 0.50%; B: 0.0010 to 0.0080%; Bi: 0.0005 to 0.0100%; and Ni: 0.02 to 1.00%.

### Effects of the Invention

According to the present invention, it is possible to provide a method for stably manufacturing a grain-oriented electrical steel sheet having a sheet thickness of 0.15 to 0.23 mm and having excellent magnetic characteristics (low iron loss and a high magnetic flux density).

### BRIEF DESCRIPTION OF DRAWINGS

FIG. 1 is an example of a structure of a grain-oriented electrical steel sheet obtained through a manufacturing method in which a slab heating temperature is 1250° C. and a decarburization annealing temperature is 800° C.

FIG. 2 is an, example of a structure of a grain-oriented electrical steel sheet obtained through a manufacturing method in which a slab heating temperature is 1150° C. and a decarburization annealing temperature is 800° C.

### EMBODIMENTS FOR IMPLMENTING THE INVENTION

A method for manufacturing a grain-oriented electrical steel sheet according to an embodiment, of the present invention (hereinafter may be referred to as a “manufacturing method according to this embodiment”)

includes: heating a steel slab which contains, in, terms of mass %, C: 0.100% or less; Si: 0.80 to 7.00%; Mn: 0.05 to 1.00%; acid-soluble Al (Sol. Al): 0.0100 to 0.0700%; N: 0.0040 to 0.0120%; and Seq=S+0.406×Se: 0.0030 to 0.0150%, further optionally, Cr: 0.30% or less; Cu: 0.40% or less; Sn: 0.30% or less; Sb: 0.30% or less; P: 0.50% or less; B: 0.0080% or less; Bi: 0.0100% or less; Ni: 1.00% or less, and the remainder: Fe and impurities to lower than 1250° C. and subjecting the steel slab to hot rolling to obtain a hot-rolled steel sheet; performing hot-band annealing on the hot-rolled steel sheet; pickling and performing cold rolling on the hot-rolled steel sheet to obtain a cold-rolled steel sheet having a final sheet thickness of 0.15 to 0.23 mm; performing a decarburization nitriding treatment including decarburization annealing and nitriding on the cold-rolled steel sheet; performing final annealing on the cold-rolled steel sheet; and then applying and baking a coating liquid for insulation coating formation to the cold-rolled steel sheet which has been subjected to the final annealing, in which

(i) a mass ratio: Sol. Al/N between acid-soluble Al (Sol. Al) and N in the steel slab and the final sheet thickness d (mm) satisfy the following expression (1);

(ii) the N content of the cold-rolled steel sheet which has been subjected to the decarburization nitriding treatment is 40 to 1000 ppm; and

(iii) a decarburization annealing temperature in the decarburization annealing is lower than 1000° C.:

−4.17×d+3.63≤Sol. Al/N≤−3.10×d+4.84 (1)

The manufacturing method according to this embodiment will be described below. Although it is desirable that the manufacturing method according to this embodiment be applied to a method, for manufacturing a grain-oriented electrical steel sheet which does not have a forsterite coating, even if the manufacturing method according to this embodiment is applied to a method for manufacturing a grain-oriented electrical steel sheet which has a forsterite coating, a significant effect can be obtained.

First, the reason for limiting a component composition of a steel slab which is used as a material in the manufacturing method according to this embodiment will be described. Hereinafter, % means mass %.

### <Component Composition>

C: 0.100% or less

C is an element which is effective for controlling a primary recrystallization structure, but adversely affects the magnetic characteristics, and thus is removed through decarburization annealing before final annealing. If the C content in the steel slab exceeds 0.100%, a decarburization annealing time increases and the productivity deteriorates. For this reason, the C content is 0.100% or less. The C content is preferably 0.070% or less, and more preferably 0.060% or less.

Although a lower limit of the C content includes 0%, if the C content is reduced to less than 0.0001%, the manufacturing costs significantly increases. Thus, in view of a practical steel sheet, 0.0001% is a practical lower limit of the C content. A lower limit of the C content may be 0.0010% 0.0020%, 0.0022%, or 0.0030%.

Si: 0.80 to 7.00%

Si is an element which improves the iron loss characteristics of the grain-oriented electrical steel sheet by increasing electric resistance of the steel sheet. If the Si content is less than 0.80%, γ transformation occurs during final annealing and the alignment of a preferable crystal orientation of the steel sheet is impaired. Thus, the Si content is 0.80% or more. The Si content is preferably 1.80% or more, 1.30% or more, 2.00% or more, and more preferably 2.50% or more.

On the other hand, if the Si content exceeds 7.00%, the workability deteriorates and cracks occur during rolling. For this reason, the Si content is 7.00% or less. The Si content is preferably 4.50% or less, and more preferably 4.00% or less.

Mn: 0.05 to 1.00%

Mn is an element which prevents cracks during hot rolling and form MnS and/or MnSe functioning as an inhibitor by binding with S and/or Se. If Mn content is less than 0.05%, a sufficient effect is not exhibited. Thus, the Mn content is 0.05% or more. The Mn content is preferably 0.07% or more, and more preferably 0.09% or more.

On the other hand, if the Mn content exceeds 1.00%, a non-uniform precipitation and dispersion of MnS and/or MnSe is provided, the required secondary recrystallization structure cannot be obtained, and the magnetic flux density deteriorates. For this reason, the Mn content is 1.00% or less. The Mn content is preferably 0.80% or less, and more preferably 0.60% or less or 0.55% or less.

Acid-soluble Al (Sol. Al): 0.0100 to 0.0700%

Acid-soluble Al (Sol. Al) is an element which binds with N to generate (Al, Si) N functioning as an inhibitor. If the Sol. Al content is less than 0.0100%, a sufficient effect is not exhibited and a sufficient secondary recrystallization does not proceed. Thus, the Sol. Al content is 0.0100% or more. The Sol. Al content is preferably 0.0150% or more, and more preferably 0.0200% or more or 0.0220% or more.

On the other hand, if the Sol. Al content exceeds 0.0700%, a non-uniform precipitation and dispersion of (Al, Si) N is provided, the required secondary recrystallization structure cannot be obtained, and a magnetic flux density decreases. For this reason, the acid-soluble Al (Sol. Al) content is 0.0700% or less. The Sol. Al content is preferably 0.0550% or less. and more preferably 0.0500% or less or 0.0400% or less.

N: 0.0040 to 0.0120%

N is an element which binds with Al to form AlN functioning as an inhibitor, but forms blisters (voids) in the steel sheet during cold rolling. If the N content is less than 0.0040%, an insufficient formation of AlN is provided, Thus, the N content is 0.0040% or more. The N content is preferably 0.0050% or more, or 0.0060% or more, and more preferably 0.0070% or more.

On the, other hand, if the N content exceeds 0.0120%, there is a concern concerning the generation of blisters (voids) in the steel sheet during cold rolling. Thus, the N content is 0.0120% or less. The N content is preferably 0.0100% or less, and more preferably 0.0090% or less.

Seq=S+0.406×Se: 0.0030 to 0.0150%

S and Se are elements which bind with Mn to form MnS and/or MnSe functioning as an inhibitor. A total content of S and Se is defined using Seq=S+0.406×Se in consideration of an atomic weight ratio of S and Se.

If Seq is less than 0.0030%, a sufficient effect is not exhibited. Thus, Seq is 0.0030% or more. Seq is preferably 0.0050% or more, and more preferably 0.0070% or more. On the other hand, if Seq exceeds 0.0150%, a non-uniform precipitation and dispersion of MnS and/or MnSe is provided, the required secondary recrystallization structure cannot be obtained, and a magnetic flux density decreases. For this reason, Seq is 0.0150% or less. Seq is preferably 0.0130% or less, and more preferably 0.0110% or less.

In a chemical composition of a steel slab which is used as a material in the manufacturing method according to this embodiment, the remainder other than the above elements is Fe and impurities, but may contain one or more of Cr: 0.30% or less; Cu: 0.40% or less; Sn: 0.30% or less; Sb: 0030% or less; P: 0.50% or less; B: 0.0080% or less; Bi: 0.0100% or less, and Ni: 1.00% or less as long as the characteristics of the electrical steel sheet are not impaired. Here, even if the steel slab does not contain these components, a good effect can be obtained through the manufacturing method according to this embodiment. Therefore, the lower limit of the contents of these components are each 0%.

Cr: 0 to 0.30%

Cr is an element which contributes to the improvement of an oxide layer generated during decarburization annealing of the steel sheet, increases the intrinsic resistance of the steel sheet, and contributes to the reduction of iron loss. If the Cr content exceeds 0.30%, the effect is saturated. Thus, the Cr content is 0.30% or less. The Cr content is preferably 0.25% or less. Although a lower limit of the Cr content includes 0%, Cr content is preferably 0.02% or more from the viewpoint of surely obtaining the effect of the inclusion.

Cu: 0 to 0.40%

Cu is an element which binds with S and/or Se to form a precipitate functioning as an inhibitor, increases the intrinsic resistance of the steel sheet, and contributes to the improvement of the magnetic characteristics. When this effect is obtained, the Cu content is preferably 0.10% or more.

On the other hand, if the Cu content exceeds 0.40%, a non-uniform dispersion of the precipitate is provided and the effect of reducing iron loss is saturated. Thus, the Cu content is 0.40% or less. The Cu content is preferably 0.25% or less.

Sn: 0 to 0.30%

Sb: 0 to 0.30%

Sn and Sb are elements which increase intrinsic resistance, contributes to the reduction of iron loss, and segregates at the grain boundaries to prevent Al from being oxidized due to moisture released due to an annealing separator during final annealing (inhibitor intensities differ in accordance with coil positions due to this oxidation, a difference occurs between Goss orientation alignments of the texture, and the magnetic characteristics fluctuate in accordance with coil position).

If the contents of each of Sn and Sb exceed 0.30%, the effect of containing these is saturated. Thus, each of the Sn content and the Sb content are 0.30% or less. The contents of both of these elements are preferably 0.25% or less. Although lower limits of the Sn content and the Sb content include 0%, the contents of each of these elements are preferably 0.02% or more from the viewpoint of surely obtaining the effect.

P: 0 to 0.50%

P is an element which increases a degree of Goss orientation alignment of a texture and intrinsic resistance of the steel sheet and contributes to the reduction of iron loss. If the P content exceeds 0.50%, the effect is saturated and the rollability deteriorates. Thus, the P content is 0.50% or less. The P content is preferably 0.35% or less. Although a lower limit of the P content includes 0%, the P content is preferably 0.02% or more from the viewpoint of surely obtaining the effect.

B: 0 to 0.0080%

B is an element which binds with ;N and precipitates as complex-precipitation with MnS or MnSe to form BN functioning as an inhibitor and which contributes to the reduction of iron loss by increasing a degree of Goss orientation alignment of a texture. When this effect is obtained, the B content is preferably 0.0010% or more.

On the other hand, if the B content exceeds 0.0080%, a non-uniform precipitation and dispersion of BN is provided, the required secondary recrystallization structure cannot be obtained, and a magnetic flux density decreases. For this reason, the B content is 0.0080% or less. The B content is preferably 0.0060% or less, and more preferably 0.0040% or less.

Bi: 0 to 0.0100%

Bi is an element which stabilizes precipitates such as sulfides, strengthens a function of an inhibitor, increases a degree of Goss orientation alignment of a texture, and contributes to the reduction of iron loss. If the Bi content exceeds 0.0100%, the effect is saturated, Thus, the Bi content is 0.0100% or less. The Bi content is preferably 0.0070% or less. Although a lower limit of the Bi content includes 0%, the Bi content is preferably 0.0005% or more from the viewpoint of surely obtaining the effect of the inclusion.

Ni: 0 to 1.00%

Ni is an element which increases intrinsic resistance of the steel sheet, contributes to the reduction of iron loss, controls a metal structure of the hot-rolled steel sheet, and contributes to the improvement of the magnetic characteristics. If the Ni content exceeds 1.00%, a secondary recrystallization proceeds unstably. Thus, the Ni content is 1.00% or less. The Ni content is preferably 0.25% or less. Although a lower limit of the Ni content includes 0%, the Ni content is preferably 0.02% or more from the viewpoint of surely obtaining the effect of the inclusion.

In the steel slab which is used as a material in the manufacturing method according to this embodiment, the remainder other than the above elements is Fe and impurities. The impurities are elements which are mixed in from a steel raw material and/or in a steelmaking process and are acceptable elements as long as the characteristics of the electrical steel sheet are not impaired. For example, Mg, Ca, and the like are allowed as long as the characteristics of the electrical steel sheet are not impaired.

A relationship between the mass ratio (a ratio of content in mass %): Sol. Al/N between acid-soluble Al (Sol. Al) and, N and the final sheet thickness d of the steel sheet will be described below.

Sol. Al/N: the following expression (1) is satisfied:

−4.17×d+3.63≤Sol. Al/N≤−3.10×d+4.84 (1).

In the manufacturing method according to this embodiment, in the steel slab which is used as a material, it is important that Sol. Al/N is controlled so that the foregoing expression (1) is satisfied in accordance with the final sheet thickness of the grain-oriented electrical steel sheet to be manufactured.

The inventors of the present invention evaluated the magnetic flux density B8 by changing Sol. Al/N of the steel slab which is used as a material in the manufacturing method according to this embodiment and preparing electrical steel sheets having. different final sheet thicknesses with each Sol. Al/N.

As a result, it is found that a magnetic flux density B8 of L930 T or more is obtained in a region in which Sol. Al/N satisfies the forgoing expression (1).

On the other hand, if Sol. Al/N exceeds “−3.10×d+4.84,” it is not possible, to stably obtain a magnetic flux density B8 of 1.930 T or more. For this reason, Sol. Al/N is “−3.10×d+4.84” or less.

The reason for this is because, if Sol. Al/N exceeds “−3.10×d+4.84,” a coarse primary recrystallization inhibitor is provided, a non-uniform dispersion thereof is provided, a non-uniform primary recrystallization structure after decarburization annealing is provided, and good secondary recrystallization cannot be obtained on the entire surface of the steel sheet, and in decarburization annealing, in order to reduce the C content in the steel sheet to 25 ppm or less, it is necessary to increase an annealing temperature, and as a result, a grain size of primary recrystallization increases and it is not possible to secure a good driving force for secondary recrystallization.

On the other hand, it is found that. if Sol. Al/N is less than “−4.17×d+3.63,” a magnetic flux, density B8 of L930 T or more cannot be obtained. For this reason, Sol. Al/N is “−4.17×d+3.63” or more.

The reason for this is because, if Sol. Al/N is less than “−4.17×d+3.63,” crystals in orientation other than the Goss orientation develop in secondary recrystallization (a degree of Goss orientation alignment decreases), a magnetic flux density is reduced, and iron loss increases.

The process conditions of the manufacturing method according to this embodiment will be described below.

<Process Condition>

Steel Slab

A steel slab which is used as a material in the manufacturing method according to this embodiment is obtained by subjecting molten steel melted using a converter furnace, an electric furnace, or the like to vacuum degassing as necessary and then subjecting the steel to continuous casting or blooming rolling after ingot casting. The steel slab is usually cast to have a thickness of 150 to 350 mm, preferably 220 to 280 mm, but may be a thin slab with a thickness of 30 to 70 mm. In the case of a thin slab, there is an advantage that it is not necessary to perform a rough process to have an intermediate thickness when a hot-rolled steel sheet is manufactured.

Hot Rolling

Heating temperature: lower than 1250° C.

If a heating temperature of the steel slab to be subjected to hot rolling is 1250° C. or higher, an amount of melt scale may increase and it may be necessary to further provide a heating furnace dedicated to the implementation of the manufacturing method according to this embodiment to a manufacturing line in some cases.

Also, when the heating temperature is 1250° C. or higher. the grain growth properties in the primary recrystallization annealing significantly deteriorate and good secondary recrystallization cannot be achieved. This is because of the use of acid-soluble Al as an inhibitor in this embodiment. After primary recrystallization in decarburization annealing which will be described later, it is essential to keep an average crystal grain size of the steel sheet within the range of 20 to 23 μm to secure the magnetic characteristics of the grain-oriented electrical steel sheet. The slab heating temperature before hot rolling has a great influence on the average crystal grain size after the primary recrystallization. When the slab heating temperature is 1250° C. or higher, a large number of fine AlN precipitates on the hot-rolled steel sheet which has been subjected to hot rolling, which hinders the growth of crystal grains. On the other hand, when the slab heating temperature is lower than 1250° C., it is possible to coarsen the AlN to be precipitated, reduce the number thereof, and suppress the grain refinement due to AlN.

Furthermore, when the heating temperature is 1250° C. or higher, MnS and/or MnSe is fully dissolved and finely precipitated in the subsequent processes. This also hinders grain growth like AlN.

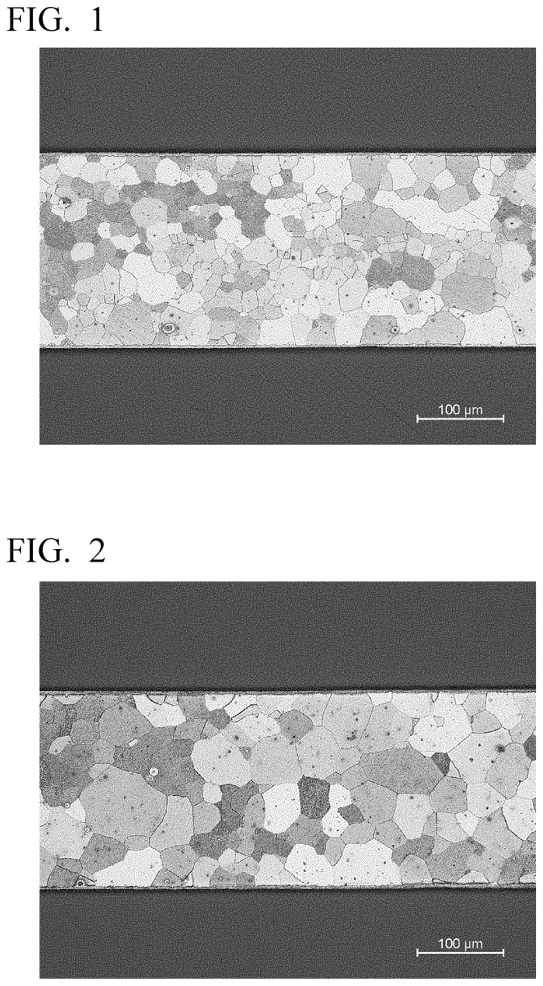

FIG. 1 is an example of a structure of a grain-oriented electrical steel sheet obtained through a manufacturing method in which a slab heating temperature is 1250° C. and a decarburization annealing temperature is 800° C. FIG. 2 is an example of a structure of a grain-oriented electrical steel sheet obtained through a manufacturing method in which a slab heating temperature is 1150° C. and a decarburization annealing temperature is 800° C. Other manufacturing conditions of the grain-oriented electrical steel sheets of FIGS. 1 and 2 are the same.

When FIGS. 1 and 2 are compared, a metal structure of the steel sheet of FIG. 1 having the slab the heating temperature of 1250° C. is clearly smaller than that of the steel sheet of FIG. 2 having the slab the heating temperature of 1150° C. It is presumed that a difference between these steel sheets is caused by the inhibition of crystal grain growth due to fine precipitates.

Even if the heating temperature of the steel slab is higher than 1250° C., it is possible to obtain the above-described desired grain size of the primary recrystallization by increasing the decarburization annealing temperature (for example, making it higher than 1000° C.). However, if the decarburization annealing temperature increases, a non-uniform primary recrystallization structure, is provided and good secondary recrystallization cannot be obtained.

For the above reasons, the heating temperature of the steel slab is set to lower than 1250° C. The heating temperature is preferably 1200° C. or lower. 1180° C. or lower, or 1150° C. or lower. It is not necessary to particularly limit a lower limit of the heating temperature of the steel slab and the conditions for carrying out normal hot rolling may be appropriately adopted. For example, the steel, slab may be heated to 1000° C. or higher, 1050° C. or higher, or 1100° C. or higher. The heated steel slab is subjected to hot rolling. Hot rolling may be performed under known conditions and the rolling conditions are not particularly limited.

Hot-Band Annealing

The hot-rolled steel sheet is subjected to hot-band annealing so that a non-uniform structure generated during hot rolling is made uniform as much as possible. The annealing conditions may be any conditions as long as the non-uniform structure generated during hot rolling can be made uniform as much as possible and are not particularly limited to specific conditions.

For example, if the hot-roiled steel sheet is heated to 1000 to 1150° C. (a first stage temperature) to recrystallize and then annealed at 850 to 1100° C. (a second stage temperature) lower than the first stage temperature, it is possible to eliminate the non-uniform structure generated during hot rolling.

In the case of this two-stage annealing, the first stage temperature has a great influence on the behavior of an inhibitor. If the first stage temperature is too high, the fine inhibitor is precipitated in a subsequent process and the decarburization annealing temperature for obtaining the desired grain size of the primary recrystallization increases. Thus, the first stage temperature is preferably 1150° C. or lower.

If the first stage temperature is too low, insufficient recrystallization is provided and the non-uniform structure generated during hot rolling cannot be made uniform. Thus, the first stage temperature is preferably 1000° C. or higher, and more preferably 1120° C. or higher.

As with the first stage temperature, if the second stage temperature is too high, the fine inhibitor is precipitated in a subsequent process and the decarburization annealing temperature for obtaining the desired grain size of the primary recrystallization increases. For this reason, the second stage temperature is preferably 1100° C. or lower, If the second stage temperature is too low, a γ phase is not generated and a hot-rolled structure cannot be made uniform. Thus, the second stage temperature is preferably 850° C. or higher, and more preferably 900° C. or higher.

Pickling and Cold Rolling

Final sheet thickness: 0.15 to 0.23 mm

A cold-rolled the steel sheet having a final sheet thickness of 0.15 to 0.2 mm is obtained by performing pickling and then cold rolling on a hot-rolled steel sheet which has been subjected to hot-band annealing so that, a non-uniform structure during hot rolling has been eliminated. It is desirable that the cold rolling be a single cold rolling process or two or more cold rolling processes having intermediate annealing performed between-the cold rolling processes.

The cold rolling may be performed at room temperature or may be performed by increasing the temperature of the steel sheet to a temperature higher than room temperature, for example, about 200° C. (so-called warm rolling). The pickling may be performed under normal conditions.

If the final sheet thickness of the cold-rolled steel sheet is less than 0.15 mm, rolling is not easy and secondary recrystallization tends to be unstable. For this reason, the final sheet thickness of the cold-rolled steel sheet is 0.15 mm or more, and preferably 0.17 mm or more.

On the other hand, if the final sheet thickness of the cold-rolled steel sheet exceeds 0.23 mm, the secondary recrystallization is too stable and an angle difference between the recrystallized grain orientation and the Goss orientation increases. For this reason, the final sheet thickness of the cold-rolled steel sheet is 0.23 mm or less, and preferably 0.21 mm or less.

Decarburization Annealing

In order to remove C contained in the cold-rolled steel sheet which has reached the final sheet thickness, the cold-rolled steel sheet is subjected to decarburization annealing in a wet hydrogen atmosphere. The wet hydrogen atmosphere, for example, is a humidifying gas with a dew point of 70° C. and is an atmosphere including a small amount of hydrogen as a gas type. To be more specific, for example annealing is performed in a humidifying gas atmosphere with a dew point of 70° C. containing 10% hydrogen.

As described above, when the temperature of the decarburization annealing is too high, a non-uniform primary recrystallization structure is provided and good secondary recrystallization cannot be obtained. For this reason, the clecarburization annealing temperature is set to lower than 1000° C. A lower limit of the decarburization annealing temperature may be appropriately selected within the range in which the above-described effects can be obtained. For example, the decarburization annealing temperature may be 750° C. or higher, 800° C. or, higher, or 850° C. or higher. Although the lower limit does not necessarily need to be set, if the decarburization annealing temperature is lower than 700° C., there is a concern that grain growth and decarburization may not proceed sufficiently. Thus, the decarburization annealing temperature is preferably 700° C. or, higher.

Also, it is desirable that the decarburization annealing be performed by controlling an annealing atmosphere in an oxidation degree at which an iron-based, oxide is not generated. For example, the oxidation degree of the annealing atmosphere is preferably 0.01 or more and less than 0.15. The oxidation degree is an oxidation potential represented by P_{H2O}/P_{H2}.

If the oxidation degree is less than 0.01, a decarburization rate decreases and the productivity deteriorates. On the other hand, if the oxidation degree is 0.15 or more, inclusions are formed below the surface of the product steel sheet and iron loss increases. A rate of temperature rise in a heating process is not particularly limited and may be, for example, 50° C./second or faster from the viewpoint of productivity

Nitriding

The cold-rolled steel sheet which has been subjected to the decarburization annealing (hereinafter referred to as a “steel sheet”) is subjected to nitriding so that the N content of the steel sheet is 40 to 1000 ppm. The nitriding is not limited to specific nitriding. For example, the nitriding is performed in an atmosphere gas having a nitriding ability such as ammonia.

If the N content in the steel sheet which has been subjected to nitriding is less than 40 ppm, a sufficient amount of AlN is not precipitated and AlN does not sufficiently function as an inhibitor. In this case, since sufficient secondary recrystallization does not proceed in the final annealing, the N content in the, steel sheet which has been subjected to nitriding is 40 ppm or more, and preferably 100 ppm or more.

On the other hand. if the N content in the steel sheet which has been subjected to nitriding exceeds 1000 ppm, AlN is present even after the secondary recrystallization is completed in the final annealing, which causes an increase in iron loss. For this reason, N in the steel sheet which has been subjected to nitriding is set to 1000 ppm or less, and preferably 850 ppm or less. A means for adjusting the N content in the steel sheet which has been subjected to nitriding to 40 to 1000 ppm is not particularly limited. Usually, the N content after the completion of the nitriding can be controlled, by controlling a partial pressure of a nitrogen source (for example, ammonia) in a Madding atmosphere, a nitriding time, and the like.

Final Annealing

Annealing Separator

An annealing separator s applied to the, steel sheet which has been subjected to nitriding and is subjected to final annealing. It is desirable that an annealing separator containing alumina as a main component which does not easily react with silica (containing 50 mass % or more of alumina) be used as the annealing separator and be applied to the surface of the steel sheet through water slurry application, electrostatic application, or the like. When the above annealing separator s utilized, the surface of the steel sheet which has been subjected to final annealing can be finished to be smooth and iron loss can be significantly reduced.

The steel sheet coated with the annealing separator is subjected to final annealing to allow secondary recrystallization to proceed and the crystal orientations to be aligned in the {110} <001> orientation.

For example, in the final annealing, a temperature is raised to 1100 to 1200° C. at a rate of temperature rise of 5 to 15° C./hour in an annealing atmosphere in which nitrogen is included, the annealing atmosphere is changed to an atmosphere of 50 to 100% hydrogen at this temperature, and annealing which also serves as purification is performed for about 20 hours. However, the final annealing conditions are not limited thereto and can be appropriately selected from known conditions.

Formation of Insulation Coating

When a coating liquid for insulation coating formation is applied to the surface of the steel sheet which has been subjected to final annealing (after the completion of secondary recrystallization) and baked, an insulation coating is formed to make a grain-oriented electrical steel sheet which is a final product. A type of the insulation coating is not limited to a specific type and may be a known insulation coating.

For example, there are insulation coatings formed by applying an aqueous coating liquid containing phosphate and colloidal silica. In the case of this insulation coating, the phosphate is preferably a phosphate such as metal phosphate of Ca, Al, Sr, and the like and more preferably an aluminum phosphate salt among these.

Colloidal silica is not limited to colloidal silica having, specific properties. particle size is also not limited to a specific particle size but is preferably 200 nm (number average particle size) or less. If the particle size exceeds 200 nm, the settlement may occur in the coating liquid. On the other hand, although there is no problem concerning dispersion even when a particle size of colloidal silica is less than 100 nm, the manufacturing costs increase, which is not practically used.

The coating liquid for insulation coating formation is applied to the surface of the steel sheet through, for example, a wet coating method such as a roll coater and baked in air at a temperature of 800 to 900° C. for 10 to 60 seconds to form, a tension insulation coating.

The grain-oriented electrical steel sheet may be subjected to a magnetic domain subdivision treatment. The magnetic domain subdivision treatment is preferable because grooves are formed in the surface of the steel sheet and a width of the magnetic domains is reduced, resulting in a reduction in iron loss. Although a specific method of the magnetic domain subdivision treatment is not particularly limited, for example, laser irradiation, electron beam irradiation, etching, groove formation through gears or the like can be exemplified.

### EXAMPLES

Although examples of the present invention will be described below, the conditions in the examples are one condition example adopted for confirming the feasibility and the effect of the present invention and the present invention is not limited to this one condition example. The present invention may adopt various conditions as long as the gist of the present invention is not deviated and the object of the present invention is achieved.

### Example 1

A cold-rolled steel sheet having a final sheet thickness of 0.27 mm, 0.23 mm, 0.20 mm, 0.18 mm, 0.15 mm, or 0.13 mm was obtained by heating the steel slab having the component composition shown in Table I (the remainder: Fe and impurities) to 1150° C. and subjecting the steel slab to hot rolling to obtain a hot-rolled steel sheet having a sheet thickness of 2.6 mm, subjecting the hot-rolled steel sheet to hot-band annealing at the first stage temperature of 1100° C. and the second stage temperature of 900° C., and pickling the hot-rolled steel sheet and performing a single cold rolling process or multiple cold rolling processes having intermediate annealing performed between the cold rolling processes.

TABLE 1

| Steel | Chemical composition (mass %) | | | | | | | |
|---|---|---|---|---|---|---|---|---|
| No. | C | Si | Mn | Al | N | Seq | Sol-Al/N | Others |
| A1 | 0.082 | 3.45 | 0.12 | 0.0285 | 0.0070 | 0.0065 | 4.07 | |
| A2 | 0.060 | 3.35 | 0.10 | 0.0290 | 0.0070 | 0.0055 | 4.14 | |
| A3 | 0.072 | 2.50 | 0.45 | 0.0241 | 0.0090 | 0.0070 | 2.68 | B 0.0015 |
| A4 | 0.088 | 3.60 | 0.10 | 0.0241 | 0.0090 | 0.0066 | 2.68 | Cr 0.02 |
| A5 | 0.045 | 3.95 | 0.08 | 0.0240 | 0.0080 | 0.0063 | 3.00 | Cu 0.18 |
| A6 | 0.032 | 4.20 | 0.30 | 0.0350 | 0.0080 | 0.0080 | 4.38 | P 0.25 |
| A7 | 0.045 | 1.92 | 0.05 | 0.0390 | 0.0090 | 0.0082 | 4.33 | |
| A8 | 0.048 | 3.45 | 0.10 | 0.0240 | 0.0055 | 0.0066 | 4.36 | Ni 0.05 |
| A9 | 0.055 | 4.21 | 0.13 | 0.0321 | 0.0120 | 0.0063 | 2.68 | |
| A10 | 0.091 | 3.35 | 0.25 | 0.0262 | 0.0060 | 0.0054 | 4.37 | Bi 0.0015 |
| A11 | 0.099 | 3.45 | 0.14 | 0.0350 | 0.0083 | 0.0040 | 4.22 | |
| A12 | 0.025 | 3.35 | 0.12 | 0.0350 | 0.0080 | 0.0100 | 4.38 | |
| A13 | 0.031 | 3.92 | 0.10 | 0.0330 | 0.0079 | 0.0060 | 4.18 | Sb 0.2 |
| A14 | 0.045 | 3.15 | 0.32 | 0.0330 | 0.0080 | 0.0055 | 4.13 | Sn 0.01 |
| A15 | 0.077 | 4.32 | 0.12 | 0.0300 | 0.0100 | 0.0065 | 3.00 | |
| A16 | 0.089 | 3.35 | 0.52 | 0.0350 | 0.0081 | 0.0065 | 4.32 | |
| A17 | 0.046 | 0.93 | 0.12 | 0.0285 | 0.0070 | 0.0065 | 4.07 | |
| A18 | 0.046 | 6.68 | 0.12 | 0.0285 | 0.0070 | 0.0065 | 4.07 | |
| A19 | 0.060 | 3.35 | 0.05 | 0.0290 | 0.0070 | 0.0055 | 4.14 | |
| A20 | 0.060 | 3.35 | 0.98 | 0.0290 | 0.0070 | 0.0055 | 4.14 | |
| A21 | 0.045 | 1.92 | 0.05 | 0.0150 | 0.0040 | 0.0082 | 3.75 | |
| A22 | 0.048 | 3.45 | 0.10 | 0.0500 | 0.0120 | 0.0066 | 4.17 | |

The cold-rolled steel sheet having a final sheet thickness of 0.27 mm, 0.23 mm, 0.20 mm, 0.18 mm, 0.15 mm, or 0.13 mm was subjected to the decarburization annealing and nitriding (annealing in which the nitrogen content in the steel sheet is increased). To be specific, the decarburization annealing was performed at a rate, of temperature rise of 100° C./second with an oxidation degree of an atmosphere set to 0.12. A soaking temperature of decarburization annealing is shown in Table 2. After that, the cold-rolled steel sheet was subjected to nitriding so that the nitrogen content shown in Table 2 was obtained.

An annealing separator containing alumina as a main component was applied to the surface of the steel sheet which has been subjected to decarburization annealing and nitriding. heated at a rate of temperature rise of 15° C./hour, and subjected to final annealing at 1200° C. Furthermore, an aqueous coating liquid containing phosphate and colloidal silica was applied and baked in air at a temperature of 800′° C. for 60 seconds to form an insulation coating (a tension insulation coating).

It was confirmed whether the foregoing expression (1) was satisfied in the steel sheet which has not been subjected to nitriding and the nitrogen content and the carbon content of the steel sheet which has been subjected to a decarburization nitriding treatment were measured.

A magnetic flux density B8 (T) and iron loss W_{17/50} of the steel sheet which has been subjected to the final annealing and the insulation coating formation and the magnetic domain control were measured. Since the iron loss W_{17/50} varies significantly depending on a sheet thickness, examples in which sheet thicknesses were 0.27 mm, 0.23 mm, 0.20 mm, 0.18 mm, 0.15 mm, and 0.13 mm and iron losses were 0.75 W/kg or less, 0.65 W/kg or less, 0.62 W/kg or less, 0.55 W/kg or less, 0.50 W/kg or less, and 0.45 W/kg or less, respectively, were regarded as examples in which good magnetic characteristics were obtained. If the magnetic flux density B8 (T) was 1.930 T or more, it was regarded as an example in which good magnetic characteristics were obtained.

TABLE 2

| | | | Slab heating | Sheet thickness | | | |
|---|---|---|---|---|---|---|---|
| | | | temperature | of cold-rolled | Expression (1) | | |
| | No. | Steel No. | (° C.) | steel sheet (mm) | Lower limit | Sol-Al/N | Upper limit |
| Example of | B1 | A1 | 1150 | 0.20 | 2.80 | 4.07 | 4.22 |
| present | B2 | A2 | 1150 | 0.20 | 2.80 | 4.14 | 4.22 |
| invention | B3 | A3 | 1150 | 0.23 | 2.67 | 2.68 | 4.13 |
| | B4 | A4 | 1150 | 0.23 | 2.67 | 2.68 | 4.13 |
| | B5 | A5 | 1150 | 0.20 | 2.80 | 3.00 | 4.22 |
| | B6 | A6 | 1150 | 0.15 | 3.00 | 4.38 | 4.38 |
| | B7 | A7 | 1150 | 0.15 | 3.00 | 4.33 | 4.38 |
| | B8 | A8 | 1150 | 0.15 | 3.00 | 4.36 | 4.38 |
| | B9 | A9 | 1150 | 0.23 | 2.67 | 2.68 | 4.13 |
| | B10 | A10 | 1150 | 0.15 | 3.00 | 4.37 | 4.38 |
| | B11 | A11 | 1150 | 0.20 | 2.80 | 4.22 | 4.22 |
| | B12 | A12 | 1150 | 0.15 | 3.00 | 4.38 | 4.38 |
| | B13 | A13 | 1150 | 0.20 | 2.80 | 4.18 | 4.22 |
| | B14 | A14 | 1150 | 0.23 | 2.67 | 4.13 | 4.13 |
| | B15 | A15 | 1150 | 0.18 | 2.88 | 3.00 | 4.28 |
| | B16 | A16 | 1150 | 0.15 | 3.00 | 4.32 | 4.38 |
| | B17 | A17 | 1150 | 0.23 | 2.67 | 4.07 | 4.13 |
| | B18 | A18 | 1150 | 0.23 | 2.67 | 4.07 | 4.13 |
| | B19 | A19 | 1150 | 0.18 | 2.88 | 4.14 | 4.28 |
| | B20 | A20 | 1150 | 0.18 | 2.88 | 4.14 | 4.28 |
| | B21 | A21 | 1150 | 0.15 | 3.00 | 3.75 | 4.38 |
| | B22 | A22 | 1150 | 0.15 | 3.00 | 4.17 | 4.38 |
| Comparative | C1 | A1 | 1150 | 0.27 | 2.50 | 4.07 | 4.00 |
| example | C2 | A2 | 1150 | 0.27 | 2.50 | 4.14 | 4.00 |
| | C3 | A3 | 1150 | 0.20 | 2.80 | 2.68 | 4.22 |
| | C4 | A4 | 1150 | 0.18 | 2.88 | 2.68 | 4.28 |
| | C5 | A5 | 1150 | 0.13 | 3.09 | 3.00 | 4.44 |
| | C6 | A6 | 1150 | 0.18 | 2.88 | 4.38 | 4.28 |
| | C7 | A7 | 1150 | 0.23 | 2.67 | 4.33 | 4.13 |
| | C8 | A8 | 1150 | 0.18 | 2.88 | 4.36 | 4.28 |
| | C9 | A9 | 1150 | 0.18 | 2.88 | 2.68 | 4.28 |
| | C10 | A10 | 1150 | 0.23 | 2.67 | 4.37 | 4.13 |
| | C11 | A11 | 1150 | 0.23 | 2.67 | 4.22 | 4.13 |
| | C12 | A12 | 1150 | 0.18 | 2.88 | 4.38 | 4.28 |
| | C13 | A13 | 1150 | 0.23 | 2.67 | 4.18 | 4.13 |
| | C14 | A14 | 1150 | 0.27 | 2.50 | 4.13 | 4.00 |
| | C15 | A15 | 1150 | 0.13 | 3.09 | 3.00 | 4.44 |
| | C16 | A16 | 1150 | 0.27 | 2.50 | 4.32 | 4.00 |

| | Decarburization | Nitrogen content after | Carbon content after | | Magnetic characteristics | |
|---|---|---|---|---|---|---|
| | annealing | decarburization and | decarburization and | Magnetic domain | Magnetic flux | Iron loss |
| No. | temperature (° C.) | nitriding (ppm) | nitriding (ppm) | control method | density B8 (T) | W_{17/50} (W/kg) |
| B1 | 820 | 200 | 12 | Laser irradiation | 1.945 | 0.59 |
| B2 | 830 | 210 | 15 | Laser irradiation | 1.944 | 0.61 |
| B3 | 870 | 198 | 17 | Laser irradiation | 1.943 | 0.63 |
| B4 | 880 | 185 | 23 | Laser irradiation | 1.942 | 0.62 |
| B5 | 870 | 190 | 22 | Laser irradiation | 1.944 | 0.60 |
| B6 | 780 | 230 | 19 | Laser irradiation | 1.945 | 0.40 |
| B7 | 820 | 211 | 21 | Laser irradiation | 1.950 | 0.45 |
| B8 | 790 | 198 | 22 | Laser irradiation | 1.938 | 0.48 |
| B9 | 850 | 211 | 24 | Laser irradiation | 1.938 | 0.65 |
| B10 | 800 | 213 | 21 | Laser irradiation | 1.939 | 0.48 |
| B11 | 810 | 225 | 19 | Laser irradiation | 1.941 | 0.61 |
| B12 | 800 | 241 | 18 | Laser irradiation | 1.942 | 0.49 |
| B13 | 810 | 251 | 22 | Laser irradiation | 1.942 | 0.62 |
| B14 | 790 | 255 | 22 | Gear | 1.939 | 0.62 |
| B15 | 880 | 194 | 21 | Etching | 1.941 | 0.54 |
| B16 | 810 | 201 | 22 | Electron beam | 1.942 | 0.50 |
| B17 | 820 | 220 | 18 | Laser irradiation | 1.941 | 0.63 |
| B18 | 830 | 222 | 21 | Electron beam | 1.939 | 0.61 |
| B19 | 820 | 232 | 22 | Gear | 1.939 | 0.52 |
| B20 | 820 | 210 | 24 | Laser irradiation | 1.941 | 0.54 |
| B21 | 825 | 214 | 22 | Electron beam | 1.940 | 0.48 |
| B22 | 830 | 221 | 19 | Laser irradiation | 1.940 | 0.49 |
| C1 | 810 | 201 | 35 | Laser irradiation | 1.940 | 0.80 |
| C2 | 810 | 206 | 52 | Laser irradiation | 1.943 | 0.81 |
| C3 | 840 | 211 | 21 | Laser irradiation | 1.750 | 1.00 |
| C4 | 830 | 188 | 22 | Laser irradiation | 1.763 | 1.05 |
| C5 | 820 | 189 | 25 | Laser irradiation | 1.823 | 0.90 |
| C6 | 780 | 255 | 43 | Laser irradiation | 1.935 | 0.70 |
| C7 | 780 | 186 | 35 | Laser irradiation | 1.941 | 0.75 |
| C8 | 780 | 190 | 33 | Laser irradiation | 1.943 | 0.72 |
| C9 | 840 | 189 | 22 | Laser irradiation | 1.560 | 1.04 |
| C10 | 790 | 189 | 45 | Laser irradiation | 1.939 | 0.72 |
| C11 | 800 | 190 | 42 | Laser irradiation | 1.934 | 0.75 |
| C12 | 800 | 191 | 41 | Laser irradiation | 1.941 | 0.65 |
| C13 | 810 | 199 | 44 | Laser irradiation | 1.938 | 0.82 |
| C14 | 810 | 188 | 51 | Gear | 1.937 | 0.81 |
| C15 | 900 | 210 | 21 | Etching | 1.821 | 0.88 |
| C16 | 810 | 222 | 36 | Electron beam | 1.933 | 0.83 |

In the example of the present invention in which the conditions of the present invention are satisfied, the carbon content (the C content) after the decarburization nitriding treatment is as small as 25 ppm or less and the magnetic characteristics shown by the magnetic flux density B8 and the iron loss W_{17/50} are good. On the other hand, in comparative examples in which the conditions of the present invention are not satisfied, the carbon content is large. Thus, an inferior iron loss W_{17/50} is provided or a poor secondary recrystallization is provided, and a low magnetic flux density is provided and an inferior iron loss W_{17/50} is provided.

### Example 2

A cold-rolled steel sheet having a final sheet thickness of 0.23 mm or 0.20 mm was obtained by subjecting the steel slab having the component composition shown in Table 1 to hot rolling at various slab heating temperatures listed in Table 3 to obtain a hot-rolled steel sheet having a sheet thickness of 2.6 mm, subjecting the hot-rolled steel sheet to hot-band annealing at the first stage temperature of 1100° C. and the second stage temperature of 900° C., and pickling the hot-rolled steel sheet and performing a single cold rolling process or multiple cold rolling processes having intermediate annealing performed between the cold rolling processes.

The cold-rolled steel sheet having a final sheet thickness of 0.23 mm or 0.20 mm was subjected to the decarburization annealing and nitriding (annealing in which the nitrogen content in the steel sheet is increased). The decarburization annealing was performed at a rate of temperature rise of 80° C./second with an oxidation degree of an atmosphere set to 0.12. A soaking temperature of decarburization annealing was as shown in Table 3. After that, the cold-rolled steel sheet was subjected to nitriding so that the nitrogen content (the N content) listed in Table 3 was obtained. An annealing separator containing alumina as a main component was applied to the surface of the steel sheet which has been subjected to decarburization annealing and nitriding, heated at a rate of temperature rise of 15° C./hour, and subjected to final annealing at 1200° C. Furthermore, an aqueous coating liquid containing phosphate and colloidal silica was applied and baked in air at a temperature of 800° C. for 60 seconds to form a tension insulation coating.

It was confirmed whether the foregoing expression (1) was satisfied in the steel sheet which has not been subjected to nitriding and the nitrogen content and the carbon content of the steel sheet which has been subjected to a decarburization nitriding treatment were measured. Furthermore, a magnetic flux density B8 (T) and iron loss W_{17/50} of the steel sheet which has been subjected to the final annealing and the insulation coating formation and the magnetic domain control through laser irradiation were measured. The evaluation criteria were the same as in Example 1. The results are shown in Table 3.

TABLE 3

| | | | Slab heating | Sheet thickness | | | |
|---|---|---|---|---|---|---|---|
| | | | temperature | of cold-rolled | (1) Expression | | |
| | No. | Steel No. | (° C.) | steel sheet (mm) | Lower limit | Sol-Al/N | Upper limit |
| Example of | D1 | A1 | 1150 | 0.20 | 2.80 | 4.07 | 4.22 |
| present | D2 | A2 | 1200 | 0.20 | 2.80 | 4.14 | 4.22 |
| invention | D3 | A3 | 1240 | 0.23 | 2.67 | 2.68 | 4.13 |
| | D4 | A5 | 1230 | 0.20 | 2.80 | 3.00 | 4.22 |
| | D5 | A9 | 1200 | 0.23 | 2.67 | 2.68 | 4.13 |
| | D6 | A11 | 1180 | 0.20 | 2.80 | 4.22 | 4.22 |
| | D7 | A13 | 1200 | 0.20 | 2.80 | 4.18 | 4.22 |
| | D8 | A14 | 1230 | 0.23 | 2.67 | 4.13 | 4.13 |
| Comparative | E1 | A1 | 1260 | 0.20 | 2.80 | 4.07 | 4.22 |
| example | E2 | A2 | 1280 | 0.20 | 2.80 | 4.14 | 4.22 |
| | E4 | A3 | 1350 | 0.23 | 2.67 | 2.68 | 4.13 |
| | E5 | A5 | 1270 | 0.20 | 2.80 | 3.00 | 4.22 |
| | E6 | A9 | 1280 | 0.23 | 2.67 | 2.68 | 4.13 |
| | E7 | A11 | 1300 | 0.20 | 2.80 | 4.22 | 4.22 |
| | E8 | A13 | 1280 | 0.20 | 2.80 | 4.18 | 4.22 |
| | E9 | A14 | 1270 | 0.23 | 2.67 | 4.13 | 4.13 |

| | Decarburization | Nitrogen content after | Carbon content after | | Magnetic characteristics | |
|---|---|---|---|---|---|---|
| | annealing | decarburization and | decarburization and | Magnetic domain | Magnetic flux | Iron loss |
| No. | temperature (° C.) | nitriding (ppm) | nitriding (ppm) | control method | density B8 (T) | W_{17/50} (W/kg) |
| D1 | 820 | 200 | 12 | Laser irradiation | 1.945 | 0.59 |
| D2 | 830 | 210 | 15 | Laser irradiation | 1.944 | 0.61 |
| D3 | 870 | 198 | 17 | Laser irradiation | 1.943 | 0.63 |
| D4 | 870 | 190 | 22 | Laser irradiation | 1.944 | 0.60 |
| D5 | 850 | 211 | 24 | Laser irradiation | 1.938 | 0.65 |
| D6 | 810 | 225 | 19 | Laser irradiation | 1.941 | 0.61 |
| D7 | 810 | 251 | 22 | Laser irradiation | 1.942 | 0.62 |
| D8 | 790 | 255 | 22 | Laser irradiation | 1.939 | 0.62 |
| E1 | 880 | 211 | 21 | Laser irradiation | 1.880 | 0.70 |
| E2 | 890 | 188 | 22 | Laser irradiation | 1.870 | 0.72 |
| E4 | 920 | 186 | 22 | Laser irradiation | 1.560 | 1.25 |
| E5 | 880 | 190 | 23 | Laser irradiation | 1.870 | 0.73 |
| E6 | 830 | 189 | 22 | Laser irradiation | 1.850 | 0.77 |
| E7 | 880 | 189 | 18 | Laser irradiation | 1.560 | 1.20 |
| E8 | 880 | 190 | 22 | Laser irradiation | 1.780 | 1.21 |
| E9 | 920 | 191 | 24 | Laser irradiation | 1.820 | 0.87 |

In the example of the present invention in which the slab the heating temperature is lower than 1250° C., good magnetic characteristics shown by the magnetic flux density B8 and the iron loss W_{17/50} are provided. whereas in the comparative examples in which the slab heating conditions of the present invention are not satisfied, poor secondary recrystallization is provided, a low magnetic flux density is provided, and an inferior iron loss W_{17/50} is provided.

### Example 3

A cold-rolled steel sheet having a final sheet thickness of 0.23 mm or 0.20 mm was obtained by subjecting the steel slab having the component composition shown in Table 1 to hot rolling at 1150° C. to, obtain a hot-rolled steel sheet having a sheet thickness of 2.6 mm, subjecting the hot-rolled steel sheet to hot-band annealing at the first stage temperature of 1100° C. and the second stage temperature of 900° C., subjecting the hot-rolled steel sheet to annealing at 900° C., and then pickling the hot-rolled steel sheet and performing a single cold rolling process or multiple cold rolling processes having intermediate annealing performed between the cold rolling processes.

The cold rolled steel sheet having a final sheet thickness of 0.23 mm or 0.20 mm was subjected to the decarburization annealing and nitriding (annealing in which the nitrogen content in the steel sheet is increased). The decarburization annealing was performed at a rate of temperature rise of 100° C./second with an oxidation degree of an atmosphere set to 0.12. A soaking temperature of decarburization annealing is shown in Table 4. After that, the cold-rolled steel sheet was subjected to nitriding so that the nitrogen content shown in Table 4 was obtained. An annealing separator containing alumina as a main component was applied to the surface of the steel sheet which has been subjected to decarburization annealing and nitriding, heated at a rate of temperature rise of 15° C./hour, and subjected to final annealing at 1200° C. Furthermore, an aqueous coating liquid containing phosphate and colloidal silica was applied and baked in air at a temperature of 800° C. for 60 seconds to form a tension insulation, coating.

It was confirmed whether the foregoing expression (1) was satisfied in the steel sheet which has not been subjected to nitriding and the nitrogen content and the carbon content of the steel sheet which has been subjected to a decarburization nitriding treatment were measured. Furthermore. ,a magnetic flux density B8 (T) and iron loss W_{17/50} of the steel sheet which has been subjected to the final annealing and the insulation coating formation and the magnetic domain control through laser irradiation were measured. The evaluation criteria were the same as in Example 1. The results are shown in Table 4.

TABLE 4

| | | | Slab heating | Sheet thickness | | | | Decarburization |
|---|---|---|---|---|---|---|---|---|
| | | | temperature | of cold-rolled | (1) Expression | | | annealing |
| | No. | Steel No. | (° C.) | steel sheet (mm) | Lower limit | Sol-Al/N | Upper limit | temperature (° C.) |
| Example of | F1 | A1 | 1150 | 0.20 | 2.80 | 4.07 | 4.22 | 820 |
| present | F2 | A2 | 1150 | 0.20 | 2.80 | 4.14 | 4.22 | 830 |
| invention | F3 | A3 | 1150 | 0.23 | 2.67 | 2.68 | 4.13 | 870 |
| | F4 | A5 | 1150 | 0.20 | 2.80 | 3.00 | 4.22 | 870 |
| | F5 | A9 | 1150 | 0.23 | 2.67 | 2.68 | 4.13 | 850 |
| | F6 | A11 | 1150 | 0.20 | 2.80 | 4.22 | 4.22 | 810 |
| Comparative | G1 | A1 | 1150 | 0.20 | 2.80 | 4.07 | 4.22 | 840 |
| example | G2 | A2 | 1150 | 0.20 | 2.80 | 4.14 | 4.22 | 780 |
| | G3 | A3 | 1150 | 0.23 | 2.67 | 2.68 | 4.13 | 790 |
| | G4 | A5 | 1150 | 0.20 | 2.80 | 3.00 | 4.22 | 800 |
| | G5 | A9 | 1150 | 0.23 | 2.67 | 2.68 | 4.13 | 810 |
| | G6 | A11 | 1150 | 0.20 | 2.80 | 4.22 | 4.22 | 810 |

| | Nitrogen content after | Carbon content after | | Magnetic characteristics | |
|---|---|---|---|---|---|
| | decarburization and | decarburization and | Magnetic domain | Magnetic flux | Iron loss |
| No. | nitriding (ppm) | nitriding (ppm) | control method | density B8 (T) | W_{17/50} (W/kg) |
| F1 | 820 | 12 | Laser irradiation | 1.945 | 0.59 |
| F2 | 936 | 15 | Laser irradiation | 1.944 | 0.61 |
| F3 | 71 | 17 | Laser irradiation | 1.943 | 0.63 |
| F4 | 82 | 22 | Laser irradiation | 1.944 | 0.60 |
| F5 | 60 | 24 | Laser irradiation | 1.938 | 0.65 |
| F6 | 882 | 19 | Laser irradiation | 1.941 | 0.61 |
| G1 | 1012 | 21 | Laser irradiation | 1.902 | 0.72 |
| G2 | 1121 | 24 | Laser irradiation | 1.905 | 0.75 |
| G3 | 38 | 23 | Laser irradiation | 1.901 | 0.78 |
| G4 | 35 | 22 | Laser irradiation | 1.898 | 0.72 |
| G5 | 39 | 19 | Laser irradiation | 1.887 | 0.79 |
| G6 | 1105 | 18 | Laser irradiation | 1.901 | 0.75 |

In the example of the present invention in which the nitrogen content after decarburization and nitriding is within the range of 40 to 1000 ppm, a good magnetic flux density and iron loss W_{17/50} are provided. In contrast, in the comparative examples in which the nitrogen content of the present invention is not satisfied, a poor secondary recrystallization is provided, residual nitrides precipitates even after final annealing, and inferior magnetic flux density B8(T) and iron loss W_{17/50} are provided.

### Example 4

A cold-rolled steel sheet having a final sheet thickness of 0.23 mm or 0.20 mm was obtained by subjecting the steel slab having the component composition shown in Table 1 to hot rolling at 1150° C. to, obtain a hot-rolled steel sheet having a sheet thickness of 2.6 mm, subjecting the hot-rolled steel sheet to hot-band annealing at the first stage temperature of 1100° C. and the second stage temperature of 900° C., subjecting the hot-rolled steel sheet to annealing at 900° C., and then pickling the hot-rolled steel sheet and performing a single cold rolling process or multiple cold rolling processes having intermediate annealing performed between the cold rolling processes.

The cold rolled steel sheet having a final sheet thickness of 0.23 mm or 0.20 mm was subjected to the decarburization annealing and nitriding (annealing in which the nitrogen content in the steel sheet is increased). The decarburization annealing was performed at a rate of temperature rise of 100° C/second with an oxidation degree of an atmosphere set to 0.12. A soaking temperature of decarburization annealing is shown in Table 5. After that, the cold-rolled steel sheet was subjected to nitriding so that the nitrogen content shown in Table 5 is obtained. An annealing separator containing alumina as a main component was applied to the surface of the steel sheet which has been subjected to decarburization and nitriding, heated at a rate of temperature rise of 15° C./hour, and subjected to final annealing at 1200° C. Furthermore, an aqueous coating liquid containing phosphate and colloidal silica was applied and baked in air at a temperature of 800° C. for 60 seconds to form a tension insulation coating.

It was confirmed whether the foregoing expression (1) was satisfied in the steel sheet which has not been subjected to nitriding and the nitrogen content and the carbon content of the steel sheet which has been subjected to a decarburization nitriding treatment were measured. Furthermore. ,a magnetic flux density B8 (T) and iron loss W_{17/50} of the steel sheet which has been subjected to the final annealing and the insulation coating formation and the magnetic domain control through laser irradiation were measured. The evaluation criteria were the same as in Example 1. The results are shown in Table 5.

TABLE 5

| | | | Slab heating | Sheet thickness | | | | Decarburization |
|---|---|---|---|---|---|---|---|---|
| | | | temperature | of cold-rolled | (1) Expression | | | annealing |
| | No. | Steel No. | (° C.) | steel sheet (mm) | Lower limit | Sol-Al/N | Upper limit | temperature (° C.) |
| Example of | H1 | A1 | 1230 | 0.20 | 2.80 | 4.07 | 4.22 | 980 |
| present | H2 | A2 | 1230 | 0.20 | 2.80 | 4.14 | 4.22 | 890 |
| invention | H3 | A3 | 1230 | 0.23 | 2.67 | 2.68 | 4.13 | 880 |
| | H4 | A5 | 1230 | 0.20 | 2.80 | 3.00 | 4.22 | 920 |
| | H5 | A9 | 1230 | 0.23 | 2.67 | 2.68 | 4.13 | 890 |
| | H6 | A11 | 1230 | 0.20 | 2.80 | 4.22 | 4.22 | 880 |
| Comparative | I1 | A1 | 1230 | 0.20 | 2.80 | 4.07 | 4.22 | 1020 |
| example | I2 | A2 | 1230 | 0.20 | 2.80 | 4.14 | 4.22 | 1010 |
| | I3 | A3 | 1230 | 0.23 | 2.67 | 2.68 | 4.13 | 1005 |
| | I4 | A5 | 1230 | 0.20 | 2.80 | 3.00 | 4.22 | 1010 |
| | I5 | A9 | 1230 | 0.23 | 2.67 | 2.68 | 4.13 | 1020 |
| | I6 | A11 | 1230 | 0.20 | 2.80 | 4.22 | 4.22 | 1020 |

| | Nitrogen content after | Carbon content after | | Magnetic characteristics | |
|---|---|---|---|---|---|
| | decarburization and | decarburization and | Magnetic domain | Magnetic flux | Iron loss |
| No. | nitriding (ppm) | nitriding (ppm) | control method | density B8 (T) | W_{17/50} (W/kg) |
| H1 | 230 | 12 | Laser irradiation | 1.945 | 0.59 |
| H2 | 280 | 15 | Laser irradiation | 1.944 | 0.61 |
| H3 | 270 | 17 | Laser irradiation | 1.943 | 0.63 |
| H4 | 192 | 22 | Laser irradiation | 1.944 | 0.60 |
| H5 | 199 | 24 | Laser irradiation | 1.938 | 0.65 |
| H6 | 210 | 19 | Laser irradiation | 1.941 | 0.61 |
| I1 | 220 | 21 | Laser irradiation | 1.932 | 0.67 |
| I2 | 221 | 24 | Laser irradiation | 1.922 | 0.70 |
| I3 | 298 | 23 | Laser irradiation | 1.930 | 0.76 |
| I4 | 276 | 22 | Laser irradiation | 1.931 | 0.69 |
| I5 | 256 | 19 | Laser irradiation | 1.929 | 0.79 |
| I6 | 212 | 18 | Laser irradiation | 1.921 | 0.71 |

In the example of the present invention in which the decarburization annealing temperature is within the range of lower than 1000° C., magnetic characteristics shown by magnetic flux density B8 and iron loss W_{17/50} are good, and when the decarburization annealing temperature is 1000° C. or higher and outside of the range of the present, invention, a magnetic, flux density B8 and iron loss W_{17/50} are inferior to that of the examples of the present invention.

### INDUSTRIAL APPLICABILITY

As described above, according to the present invention, it is possible to stably provide a grain-oriented electrical steel sheet having a sheet thickness of 0.15 to 0.23 mm and having excellent magnetic characteristics. Therefore, the present invention is highly applicable when an electrical steel sheet is manufactured and in utilization industries.

1. A method for manufacturing a grain-oriented electrical steel sheet, comprising:
heating a steel slab which contains, in terms of mass %. C: 0.100% or less; Si: 0.80 to 7.00%; Mn: 0.05 to 1.00%; Sol. Al: 0.0100 to 0.0700%; N: 0.0040 to 0.0120%; Seq=S+0.406×Se: 0.0030 to 0.0150%; Cr: 0 to 0.30%; Cu: 0 to 0.40%; Sri: 0 to 0.30%; Sb: 0 to 0.30%; P: 0 to 0.50%; B: 0 to 0.0080%; Bi: 0 to 0.0100%; Ni: 0 to 1.00%, and the remainder: Fe and impurities to lower than 1250° C. and subjecting the steel slab to hot rolling to obtain a hot-rolled steel sheet;
performing hot-band annealing on the hot-rolled steel sheet;
pickling the hot-rolled steel sheet which has been subjected to the hot-band annealing;
subjecting the hot-rolled steel sheet which has been subjected to the pickling to cold rolling to obtain a cold-rolled steel sheet having a final sheet thickness d of 0.15 to 0.23 mm;
performing a decarburization nitriding treatment including decarburization annealing and nitriding on the cold-rolled steel sheet;
performing final annealing on the cold-rolled steel sheet which has been subjected to the decarburization nitriding treatment; and
applying a coating liquid for insulation coating formation to the cold rolled steel sheet which has been subjected to the final annealing and baking the coating liquid,
wherein Sol. Al/N which is a mass ratio between Sol. Al and N in the steel slab and the, final sheet thickness d satisfy the following expression (1),
the N content of the cold-rolled steel sheet which has been subjected to the decarburization nitriding treatment is 40 to 1000 ppm, and
a decarburization annealing temperature in the decarburization annealing is lower than 1000° C/:
−4.17×d+3.63≤Sol. Al/N≤−3.10×d+4.84 (1).

2. The method for manufacturing a grain-oriented electrical steel sheet according to claim 1, wherein the steel slab contains, in terms of mass %,
one or more of Cr: 0.02 to 0.30%;
Cu: 0.10 to 0.40%;
Sn: 0.02 to 0.30%;
Sb: 0.02 to 0.30%;
P: 0.02 to 0.50%;
B: 0.0010 to 0.0080%;
Bi: 0.0005 to 0.0100%; and
Ni: 0.02 to 1.00%.
